(19) United States
(12) Patent Application Publication
(10) Pub. No.: US 2025/0264938 A1
(43) Pub. Date: Aug. 21, 2025

(54) Shape Memory Alloy Haptics Designs

(71) Applicant: Hutchinson Technology Incorporated, Hutchinson, MN (US)

(72) Inventors: Ryan N. Ruzicka, Waconia, MN (US); Jeremy J. Stroschein, Waconia, MN (US)

(21) Appl. No.: 19/052,122

(22) Filed: Feb. 12, 2025

Related U.S. Application Data
(60) Provisional application No. 63/554,431, filed on Feb. 16, 2024.

(51) Int. Cl. G06F 3/01; F03G 7/06

(52) U.S. Cl. CPC G06F 3/016; F03G 7/06143; F03G 7/06146

(57) ABSTRACT

The present embodiments relate to shape memory alloy (SMA) haptics devices. An example device can include a fixed bow that is fixed to a base and a moving bow that is configured to move in a direction. The moving bow and fixed bow can each include a flat portion and angled portions that allow the moving bow and fixed bow to be connected at a first end and/or second end. The device can also include a SMA element that, in response to a current, is configured to actuate.

### CROSS-REFERENCE TO RELATED APPLICATIONS

The present application claims priority to U.S. Provisional Patent Application No. 63/554,431, titled “SHAPE MEMORY ALLOY HAPTICS DESIGNS,” and filed Feb. 16, 2024, the entirety of which is incorporated by reference herein.

### FIELD

The invention relates generally to haptics systems, and more particularly, to haptics systems comprising a shape memory alloy (SMA) element.

### BACKGROUND

Haptic technologies can be used in various systems (e.g., augmented reality (AR) and virtual reality (VR) systems, smartphones, tablets, computer touchpads, automotive touchscreens) to transmit tactile information using sensations such as vibration, touch, and force feedback. Virtual reality systems and real-world technologies can use haptics to enhance interactions with humans. One of the goals of haptics can be to allow a virtual reality system to make humans feel as if the experiences it portrays are real. Haptics can leverage force and tactile feedback to enable users and computers to interface with each other.

Many haptics devices can include mechanical devices in contact with the human body that can provide neuro-sensory feedback signals. These devices can include signals that represent tactile sensations from skin receptors indicating pain, pressure, temperature, texture (˜2 micrometers high by 1 mm separation) and vibration (sequences up to 1 kHz), or kinesthetic sensations from muscle, tendons, and joint receptors indicating movement, position, size, and weight. These haptics devices can improve human experience with virtual environments and control interfaces.

### SUMMARY

The present embodiments relate to shape memory alloy (SMA) haptics devices. An example device can include a fixed bow that is fixed to a base and a moving bow that is configured to move in a direction. The moving bow and fixed bow can each include a flat portion and angled portions that allow the moving bow and fixed bow to be connected at a first end and/or second end. The device can also include a SMA element that, in response to a current, is configured to actuate. A sheath or fluid can be implemented as cooling elements to dissipate heat from the SMA wires.

In an example embodiment, a haptics device is provided. The haptics device can include a moving bow and a fixed bow disposed opposite to the moving bow. The fixed bow can be configured to be fixed to a base. The moving bow and the fixed bow can be connected at each of a first end and a second end of each of the moving bow and the fixed bow. The haptics device can also include a shape memory alloy (SMA) element disposed between the fixed bow and the moving bow.

In some instances, each of the moving bow and the fixed bow include a flat portion at each of a first end and a second end and a central portion extending from the flat portion and angled relative to the flat portion.

In some instances, the SMA element connects at the first end of the fixed bow and the second end of the fixed bow.

In some instances, the haptics device further includes a set of spacers disposed between the moving bow and the fixed bow at each of the first end and at the second ends of the moving bow and the fixed bow, wherein the set of spacers are configured to electrically isolate any of the SMA element, the fixed bow, and the moving bow.

In some instances, the haptics device further includes a sheath disposed around the SMA element.

In some instances, the haptics device further includes a grease disposed between the sheath and the SMA element.

In some instances, a diameter of the sheath is greater than a diameter of the SMA element.

In some instances, a sealed cavity is formed between the moving bow and the fixed bow, and wherein a fluid is configured to be disposed in the sealed cavity, wherein the fluid comprises any of: oil, water, a water and glycol mixture, a thermally conductive grease, a silicone, and/or ammonia.

In some instances, the haptics device further includes a set of leads formed on any of the fixed bow and the base, wherein the set of leads are configured to provide a current to the SMA element.

In some instances, the device comprises two SMA elements, with each SMA element being disposed on an opposing side of the device.

In some instances, the haptics device further includes one or more fasteners connecting the base and the fixed bow, wherein the fasteners comprise rivets or screws.

In some instances, the haptics device further includes a formed compression bumper extending from the moving bow toward the fixed bow and a base compression bumper extending from base through the fixed bow and extending toward the moving bow.

In some instances, the haptics device is part of a haptics interface system configured to provide neuro-sensory feedback signals.

In another example, an actuator configured to be part of a haptics system is described. The actuator can include a moving bow configured to move and a fixed bow fixed to a base. Each of the moving bow and the fixed bow can include a flat portion at each of a first end and a second end and a central portion extending from the flat portion and angled relative to the flat portion. The actuator can also include a set of spacers disposed between the moving bow and the fixed bow at each of the first end and at the second ends of the moving bow and the fixed bow. The actuator can also include at least two shape memory alloy (SMA) wires disposed between the fixed bow and the moving bow.

In some instances, the set of spacers are configured to electrically isolate the SMA element from the moving bow.

In some instances, each of the at least two SMA wires connect at a first end at the first end of the fixed bow and at a second end at the second end of the fixed bow.

In some instances, the actuator further includes a set of leads formed on any of the fixed bow and the base, wherein the set of leads are configured to provide a current to the SMA wires.

In some instances, the actuator further includes a formed compression bumper extending from the moving bow toward the fixed bow and a base compression bumper extending from the base and toward the moving bow.

In another example, a method for manufacturing an actuator is provided. The method can include affixing a fixed bow to a base. The method can also include disposing a SMA element to the fixed bow. The method can also include connecting a moving bow to the fixed bow. Each of the moving bow and the fixed bow can comprise a flat portion and angled portions extending from the flat portion angled relative to the flat portion. The moving bow and the fixed bow can be connected at a first end and/or a second end.

In some instances, the method further includes disposing a set of spacers between the fixed bow and the moving bow at any of the first end and second ends.

In some instances, the method further includes providing a current to the SMA element, wherein providing the current to the SMA element is configured to cause the SMA element to move, thereby moving the moving bow.

In some instances, the SMA element comprises a SMA wire or a SMA ribbon.

In some instances, the method further includes affixing the SMA element to the fixed bow by any of a resistance weld, adhesive, or a crimp.

Other features and advantages of embodiments of the present invention will be apparent from the accompanying drawings and from the detailed description that follows.

### BRIEF DESCRIPTION OF THE DRAWINGS

Embodiments of the present invention are illustrated, by way of example and not limitation, in the figures of the accompanying drawings, in which like references indicate similar elements and in which:

FIG. 1 illustrates a first example SMA haptics device according to some embodiments.

FIG. 2 is an example SMA haptics design with a sheath for SMA wire cooling according to some embodiments.

FIG. 3 is an example SMA haptics device design with a tube and a thermally conductive grease according to some embodiments.

FIG. 4 illustrates an example SMA haptics device capable of immersing the SMA wire in a fluid according to some embodiments.

FIG. 5 is an illustration of an example SMA haptics device according to some embodiments.

FIG. 6 is a bottom view of an example SMA haptics device according to some embodiments.

FIG. 7 is a side view of the example SMA haptics device according to some embodiments.

FIG. 8 illustrates a side view of an example device according to some embodiments.

### DETAILED DESCRIPTION

Haptic technologies can be used in various systems (e.g., augmented reality (AR) and virtual reality (VR) systems) to transmit tactile information using sensations such as vibration, touch, and force feedback. Virtual reality systems and real-world technologies can use haptics to enhance interactions with humans. One of the goals of haptics can be to allow a virtual reality system to make humans feel as if the experiences it portrays are real. Haptics can leverage force and tactile feedback to enable users and computers to interface with each other.

Many haptics devices can include mechanical devices in contact with the human body that can provide neuro-sensory feedback signals. These devices can include signals that represent tactile sensations from skin receptors indicating pain, pressure, temperature, texture (˜2 micrometers high by 1 mm separation) and vibration (sequences up to 1 kHz), or kinesthetic sensations from muscle, tendons, and joint receptors indicating movement, position, size, and weight. These haptics devices can improve human experience with virtual environments and control interfaces.

The present embodiments relate to shape memory alloy (SMA) haptics devices. These devices can be lead free, have motion amplification through metal bows, SMA driving wires configurable for performance targets (e.g., number of wires, diameter, length), and a bow spring structure configurable for force, displacement, and natural frequency.

Further, the present embodiments provide devices, and methods relating to a SMA actuator that is configured to be part of a haptics system. An example device can include a fixed bow that is fixed to a base and a moving bow that is configured to move in a direction. The moving bow and fixed bow can each include a flat portion and angled portions that allow the moving bow and fixed bow to be connected at a first end and/or second end. The device can also include a SMA element that, in response to a current, is configured to move the moving bow.

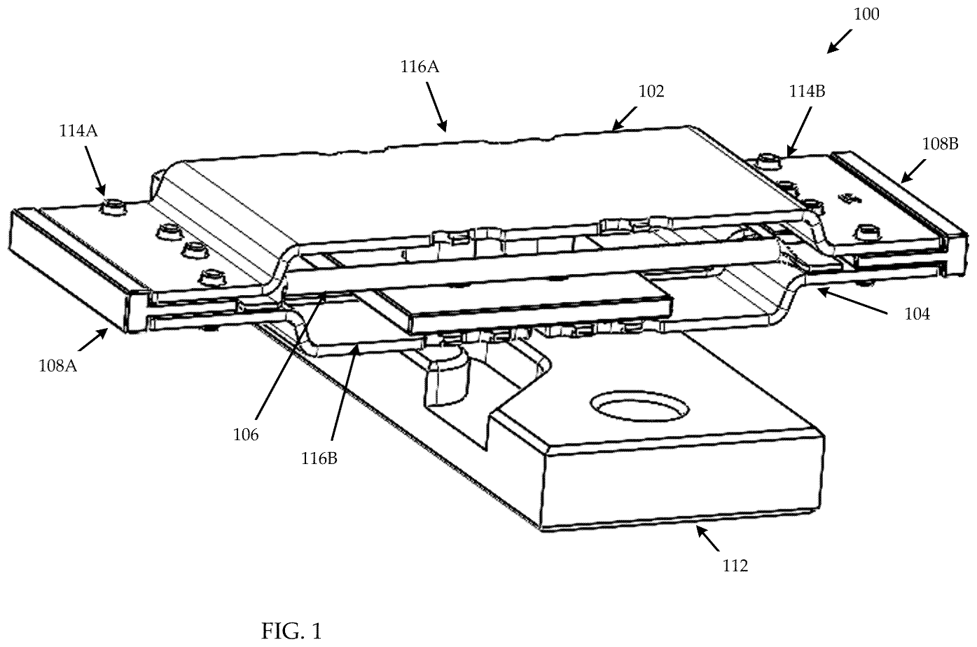

FIG. 1 illustrates a first example SMA haptics device 100. As shown in FIG. 1, the device 100 can include a moving bow 102 and a fixed bow 104. Each of the moving bow 102 and the fixed bow 104 can comprise a bow shape, with ends 114A, 114B configured to each connect to corresponding spacers 108A, 108B, and a central portion 116A, 116B. The spacers 108A, 108B can include a dielectric or non-conductive material to electrically isolate the bows 102, 104.

The moving bow 102 and fixed bow 104 can be disposed opposite to one another such that the ends 114A, 114B of the bows 102, 104 being closer in proximity than central portions 116A, 116B of the bows 102, 104.

The fixed bow 104 can be fixed to a base 112 that is configured to be static. The moving bow 102 can be configured to move in response to any of a force applied to the device 100 and/or an actuation of an SMA wire 106. The device 100 can include one or more SMA wires (e.g., 106) that are disposed at each end to ends 114A, 114B of the bows 102, 104, and the wires 106 being disposed within the cavity formed between the central portions 116A, 116B of the bows 102, 104. The SMA wire 106 at each end can be affixed to ends of either bow 102, 104 via a resistance weld, adhesive, etc.

The device 100 can further include leads to electrically connect portions of the device as described herein. For example, the leads can provide an electric current to the ends of the SMA wire 106. The leads can be formed in any of the moving bow 102 and fixed bow 104. In some embodiments, a circuit such as a flexible printed circuit (FPC) can connect elements of the device 100 as described herein.

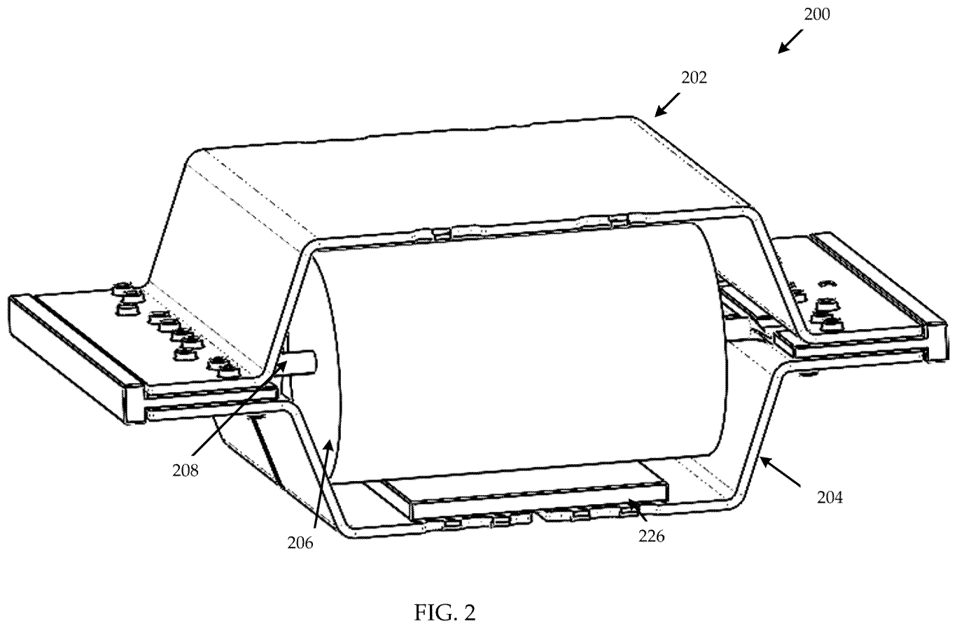

In some instances, the SMA wires can be surrounded by a sheath to provide cooling or heat dissipation of the SMA wire caused by actuation of the SMA wire. FIG. 2 is an example SMA haptics design with a sheath for SMA wire cooling. As shown in FIG. 2, the device 200 can include a moving bow 202 and a fixed bow 204 disposed opposite to one another. A SMA wire 208 can be disposed between the bows 202, 204, with a sheath 206 surrounding the SMA wire 208. The sheath can be made of a material such as silicone but could also include a material such as graphite or a multi-walled carbon nanotubes. The sheath can be attached to the SMA wire to increase surface area for higher rate of heat transfer from wire to surrounding environment to cool the wire.

The device 200 can also include a base 226 to which the fixed bow 204 is attached via a one or more fasteners such as screws. Further, a compression bumper can be formed from the base 226 and protrude through the fixed bow 204 toward the moving bow 202. The compression bumper can be disposed adjacent to a protrusion formed in the moving bow 202. Further, a circuit can be disposed between the fixed bow 204 and the base 226. While a circuit is shown, other electrical connectors can be used, such as a set of leads formed in any of the fixed bow 204 and the moving bow 202.

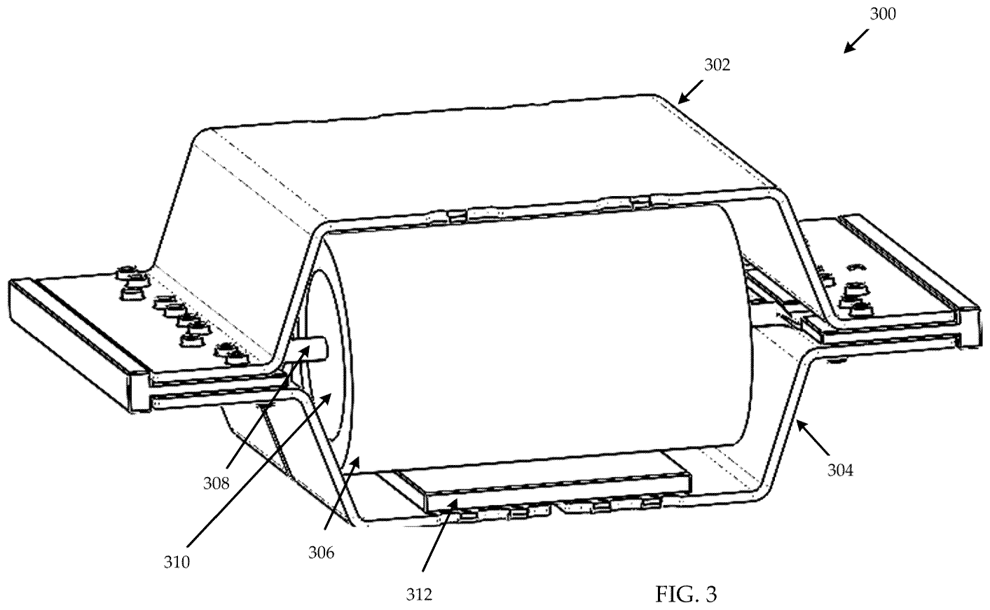

Further, in some cases, the SMA wire can be cooled via a tube and a thermally conductive grease. FIG. 3 is an example SMA haptics device design with a tube and a thermally conductive grease. As shown in FIG. 3, the device 300 can include a SMA wire 308 disposed between the moving bow 302 and the fixed bow 304, with a circuit 312 connected to the fixed bow 304. A tube 306 can surround the wire 308, with a thermally conductive grease 310 disposed between the wire 308 and the tube 306. The tube 306 can be hollow with a diameter that is larger than an outer diameter of the wire, with the hollow portion of the tube is filled with the thermally conductive grease or gel surrounding wire to cool wire.

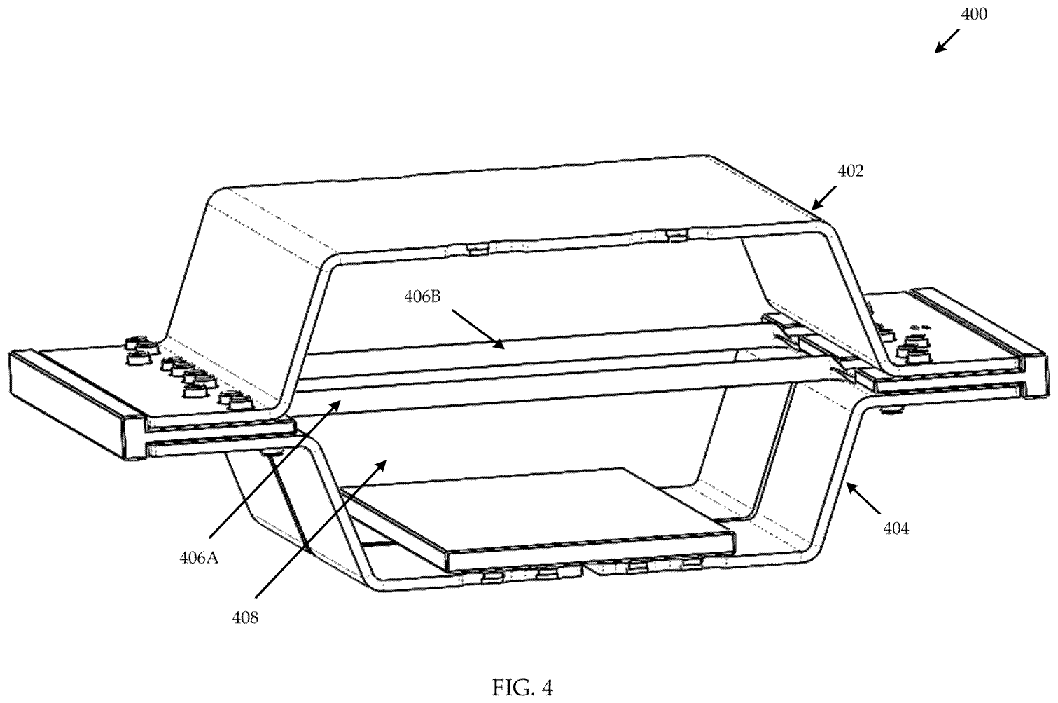

In another case, the SMA wire can be immersed in a fluid. FIG. 4 illustrates an example SMA haptics device capable of immersing the SMA wire in a fluid. As shown in FIG. 4, the device 400 can include a fluid 408 (e.g., oil, water, water with glycol, a thermally conductive grease, silicone, or ammonia) disposed in a cavity between the moving bow 402 and the fixed bow 404. The fluid 408 can surround the SMA wire 406A, 406B to cool the wire 406A, 406B by dissipating heat from the wire 406A, 406B.

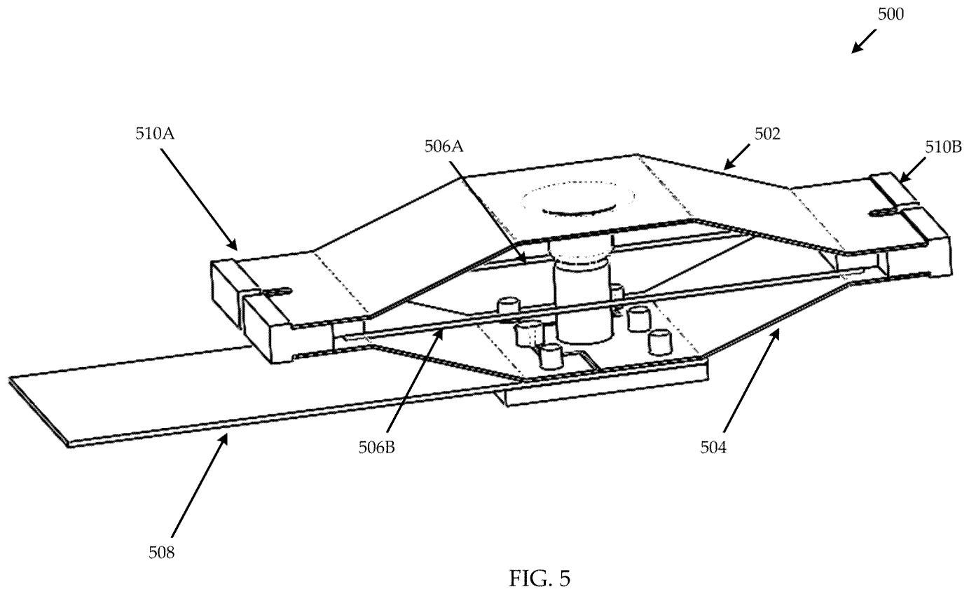

FIG. 5 is an illustration of an example SMA haptics device 500. As shown in FIG. 5, the device 500 can include a moving bow 502 and a fixed bow 504. Further, the device can include multiple configurable SMA wires 506A, 506B that, in response to a current, can cause movement of the SMA wires and can move the moving bow. The SMA wires 506A, 506B can each be disposed a side of the device as is shown in FIG. 5, for example.

The design can also include a flexible printed circuit (FPC) 508 position on the fixed bow 504. The FPC position may not inhibit the stroke of the device. While a FPC is described, another electrical connector can be used, such as a set of leads formed into the device. The device can further include spacers 510A, 510B to electrically isolate the SMA wires 106 and/or the moving bow 102 or fixed bow 104.

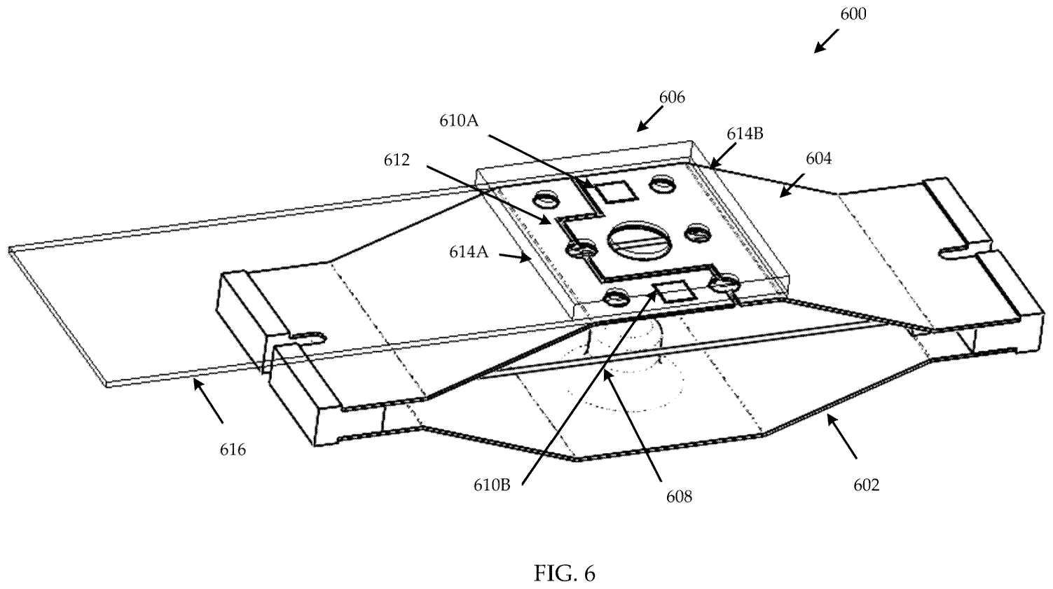

FIG. 6 is a bottom view of an example SMA haptics device 600. As shown in FIG. 6, part of a circuit 606 can be electrically connected to the fixed bow 604 or the moving bow 602. The circuit 606 can include bond pads 610A, 610B that can provide an electrical current to the SMA wire(s) 608. The bond pads can be connected to a ground and/or a base of the device.

Further, the bow 604 can include a trench 612 electrically isolating portions 614A, 614B and a flexible circuit portion 616 extending from the circuit 606. The circuit 606 as described herein can also comprise one or more traces formed into the fixed bow 604 or moving bow 602 to provide an electrical current to the device as described herein.

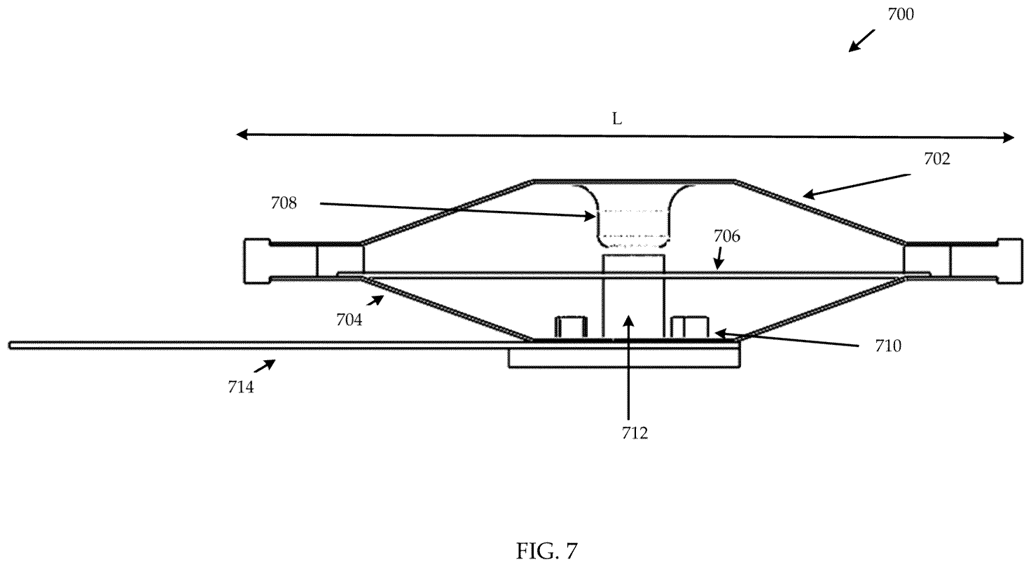

FIG. 7 is a side view of the example SMA haptics device 700. As shown in FIG. 7, the device 700 can include a formed compression bumper 708 extending from the moving bow 702 and adjacent to an integrated FPC stiffener compression bumper 712. Further, a connector such rivets 710 can securely join the split circuit stainless steel portion adjacent to the FPC 714.

The device 700 can also include a SMA wire 706 and fixed bow 704. The length L of the device can be around 13 mm but can be adjusted to achieve various performance and size targets, such as ranging from around 1 mm to 50 mm, for example.

The SMA can comprise various types, such as a SMA wire, a SMA ribbon, and/or a SMA sheet, for example. Further, the SMA elements can be attached to the device via any of a resistance weld (with or without glue over weld) and a mechanical crimp (with or without glue over crimp).

In some instances, the electrical isolation from the spacers between the moving bow and fixed bow can be moved to a non-conductive piece in the middle of the bows. Further, the bows can be joined at the ends by welding the metal.

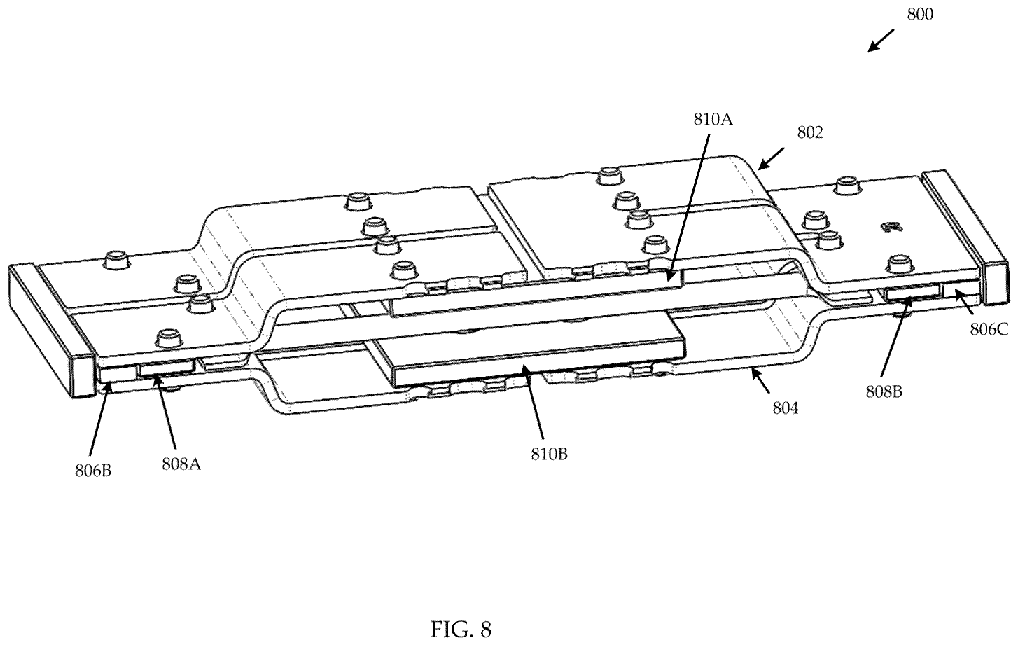

FIG. 8 illustrates a side view of an example device 800. As shown in FIG. 8, the device 800 can include a moving bow 802 and a fixed bow 804. Further, metal shims 806A-806C can be disposed between the ends of the bows 802, 804. The ends of the bows can be joined by laser welding together the moving bow 802, shim(s) 806A-C, and the fixed bow 804. The device 800 can also include non-conductive spacers 808A, 808B and non-conductive bridges 810A, 810B that can bridge the gaps in the bows 802, 804.

In an example embodiment, a haptics device is provided. The haptics device can include a moving bow and a fixed bow disposed opposite to the moving bow. The fixed bow can be configured to be fixed to a base. The moving bow and the fixed bow can be connected at each of a first end and a second end of each of the moving bow and the fixed bow. The haptics device can also include a shape memory alloy (SMA) element disposed between the fixed bow and the moving bow.

In some instances, each of the moving bow and the fixed bow include a flat portion at each of a first end and a second end and a central portion extending from the flat portion and angled relative to the flat portion.

In some instances, the SMA element connects at the first end of the fixed bow and the second end of the fixed bow.

In some instances, the haptics device further includes a set of spacers disposed between the moving bow and the fixed bow at each of the first end and at the second ends of the moving bow and the fixed bow, wherein the set of spacers are configured to electrically isolate any of the SMA element, the fixed bow, and the moving bow.

In some instances, the haptics device further includes a sheath disposed around the SMA element.

In some instances, the haptics device further includes a grease disposed between the sheath and the SMA element.

In some instances, a diameter of the sheath is greater than a diameter of the SMA element.

In some instances, a sealed cavity is formed between the moving bow and the fixed bow, and wherein a fluid is configured to be disposed in the sealed cavity, wherein the fluid comprises any of: oil, water, a water and glycol mixture, a thermally conductive grease, silicone, or ammonia.

In some instances, the haptics device further includes a set of leads formed on any of the fixed bow and the base, wherein the set of leads are configured to provide a current to the SMA element.

In some instances, the device comprises two SMA elements, with each SMA element being disposed on an opposing side of the device.

In some instances, the haptics device further includes one or more fasteners connecting the base and the fixed bow, wherein the fasteners comprise rivets or screws.

In some instances, the haptics device further includes a formed compression bumper extending from the moving bow toward the fixed bow and a base compression bumper extending from base through the fixed bow and extending toward the moving bow.

In some instances, the haptics device is part of a haptics interface system configured to provide neuro-sensory feedback signals.

In another example, an actuator configured to be part of a haptics system is described. The actuator can include a moving bow configured to move and a fixed bow fixed to a base. Each of the moving bow and the fixed bow can include a flat portion at each of a first end and a second end and a central portion extending from the flat portion and angled relative to the flat portion. The actuator can also include a set of spacers disposed between the moving bow and the fixed bow at each of the first end and at the second ends of the moving bow and the fixed bow. The actuator can also include at least two shape memory alloy (SMA) wires disposed between the fixed bow and the moving bow.

In some instances, the set of spacers are configured to electrically isolate the SMA element from the moving bow.

In some instances, each of the at least two SMA wires connect at a first end at the first end of the fixed bow and at a second end at the second end of the fixed bow.

In some instances, the actuator further includes a set of leads formed on any of the fixed bow and the base, wherein the set of leads are configured to provide a current to the SMA wires.

In some instances, the actuator further includes a formed compression bumper extending from the moving bow toward the fixed bow and a base compression bumper extending from the base and toward the moving bow.

In another example, a method for manufacturing an actuator is provided. The method can include affixing a fixed bow to a base. The method can also include disposing a SMA element to the fixed bow. The method can also include connecting a moving bow to the fixed bow. Each of the moving bow and the fixed bow can comprise a flat portion and angled portions extending from the flat portion angled relative to the flat portion. The moving bow and the fixed bow can be connected at a first end and/or a second end.

In some instances, the method further includes disposing a set of spacers between the fixed bow and the moving bow at any of the first end and second ends.

In some instances, the method further includes providing a current to the SMA element, wherein providing the current to the SMA element is configured to cause the SMA element to move, thereby moving the moving bow.

In some instances, the SMA element comprises a SMA wire or a SMA ribbon.

In some instances, the method further includes affixing the SMA element to the fixed bow by any of a resistance weld, adhesive, or a crimp.

According to some embodiments, the processes described herein are used to form one or more of any of mechanical structures and electro-mechanical structures.

Although described in connection with these embodiments, those of skill in the art will recognize that changes can be made in form and detail without departing from the spirit and scope of the invention.

What is claimed is:

1. A haptics device comprising:
a moving bow;
a fixed bow disposed opposite to the moving bow, wherein the fixed bow is configured to be fixed to a base, wherein the moving bow and the fixed bow are connected at each of a first end and a second end of each of the moving bow and the fixed bow; and
a shape memory alloy (SMA) element disposed between the fixed bow and the moving bow.

2. The haptics device of claim 1, wherein each of the moving bow and the fixed bow include a flat portion at each of a first end and a second end and a central portion extending from the flat portion and angled relative to the flat portion.

3. The haptics device of claim 2, wherein the SMA element connects at the first end of the fixed bow and the second end of the fixed bow.

4. The haptics device of claim 3, further comprising:
a set of spacers disposed between the moving bow and the fixed bow at each of the first end and at the second ends of the moving bow and the fixed bow, wherein the set of spacers are configured to electrically isolate any of the SMA element, the fixed bow, and the moving bow.

5. The haptics device of claim 1, further comprising:
a sheath disposed around the SMA element.

6. The haptics device of claim 5, further comprising:
a grease disposed between the sheath and the SMA element.

7. The haptics device of claim 5, wherein a diameter of the sheath is greater than a diameter of the SMA element.

8. The haptics device of claim 1, wherein a sealed cavity is formed between the moving bow and the fixed bow, and wherein a fluid is configured to be disposed in the sealed cavity, wherein the fluid comprises any of: oil, water, a water and glycol mixture, a thermally conductive grease, silicone, or ammonia.

9. The haptics device of claim 1, further comprising:
a set of leads formed on any of the fixed bow and the base, wherein the set of leads are configured to provide a current to the SMA element.

10. The haptics device of claim 1, wherein the device comprises two SMA elements, with each SMA element being disposed on an opposing side of the device.

11. The haptics device of claim 1, further comprising:
one or more fasteners connecting the base and the fixed bow, wherein the fasteners comprise rivets or screws.

12. The haptics device of claim 1, further comprising:
a formed compression bumper extending from the moving bow toward the fixed bow; and
a base compression bumper extending from base through the fixed bow and extending toward the moving bow.

13. The haptics device of claim 1, wherein the haptics device is part of a haptics interface system configured to provide neuro-sensory feedback signals.

14. An actuator configured to be part of a haptics system, the actuator comprising:
a moving bow configured to move;
a fixed bow fixed to a base, wherein each of the moving bow and the fixed bow include a flat portion at each of a first end and a second end and a central portion extending from the flat portion and angled relative to the flat portion;
a set of spacers disposed between the moving bow and the fixed bow at each of the first end and at the second ends of the moving bow and the fixed bow; and
at least one shape memory alloy (SMA) wire disposed between the fixed bow and the moving bow.

15. The actuator of claim 14, wherein the set of spacers are configured to electrically isolate the at least one SMA wire from the moving bow.

16. The actuator of claim 14, wherein each of the at least one SMA wire connects at a first end at the first end of the fixed bow and at a second end at the second end of the fixed bow.

17. The actuator of claim 14, further comprising:
a set of leads formed on any of the fixed bow and the base, wherein the set of leads are configured to provide a current to the at least one SMA wire.

18. The actuator of claim 14, further comprising:
a formed compression bumper extending from the moving bow toward the fixed bow; and
a base compression bumper extending from the base and toward the moving bow.

19. A method for manufacturing an actuator, the method comprising:
affixing a fixed bow to a base;
disposing a SMA element to the fixed bow; and
connecting a moving bow to the fixed bow, wherein each of the moving bow and the fixed bow comprise a flat portion and angled portions extending from the flat portion angled relative to the flat portion, wherein the moving bow and the fixed bow are connected at a first end and/or a second end.

20. The method of claim 19, further comprising:
disposing a set of spacers between the fixed bow and the moving bow at any of the first end and second ends.
